(19) United States
(12) Patent Application Publication
(10) Pub. No.: US 2021/0278825 A1
(43) Pub. Date: Sep. 9, 2021

(54) Real-Time Production Scheduling with Deep Reinforcement Learning and Monte Carlo Tree Research

(71) Applicant: Siemens Aktiengesellschaft, Munich (DE)

(72) Inventors: Chengtao Wen, Redwood City, CA (US); Wei Xi Xia, Daly City, CA (US); Juan L. Aparicio Ojea, Moraga, NJ (US)

(21) Appl. No.: 17/260,252

(22) PCT Filed: Aug. 23, 2018
(86) PCT No.: PCT/US2018/047628

§ 371 Date: Jan. 14, 2021

(51) Int. Cl. G05B 19/418; G06N 3/08; G06N 7/00

(52) U.S. Cl. CPC G05B 19/41865; G06N 7/005; G06N 3/084; G05B 19/41885

(57) ABSTRACT

Systems and methods provide real-time production scheduling by integrating deep reinforcement learning and Monte Carlo tree search. A manufacturing process simulator is used to train a deep reinforcement learning agent to identify the sub-optimal policies for a production schedule. A Monte Carlo tree search agent is implemented to speed up the search for near-optimal policies of higher quality from the sub-optimal policies.

### FIELD

Embodiments relate to generating real time production schedules for manufacturing facilities.

### BACKGROUND

Production scheduling is concerned with efforts to provide that the resources of a manufacturing system are well utilized so that the products are produced within reasonable conformity with customer demand. Production scheduling aims to maximize the efficiency of the operation and reduce costs. The benefits of production scheduling include reducing process change-over time, efficiently managing inventory, increased production efficiency, balanced labor load, real time optimization, and the ability to provide fast turnaround for customer orders. A production scheduler identifies what resources would be consumed or used at each stage of production, and generates a schedule so that the company or plant doesn't fall short of resources at the time of production.

While generating an initial production schedule is important, real time or dynamic production scheduling allows for agile and flexible manufacturing systems. On-demand manufacturing and mass customization (high-mix low-volume manufacturing) generate a need to speed up solutions to large-scale production schedule problems, e.g. reduce solving from several hours to several minutes. Fast changing market conditions may even require the solving time of a production schedule to be comparable to the process time constants.

### SUMMARY

By way of introduction, the preferred embodiments described below include methods and systems for a fast production scheduling approach based on deep reinforcement learning (DRL) and Monte Carlo Tree Search (MCTS). A DRL agent is used to identify one or more possible policies based on simulated data from a manufacturing process simulator. The MCTS provides an efficient and quick real time search to identify the optimal policy from the one or more possible policies. The methods and systems provide a fast scheduling program that mitigates uncertainties within manufacturing systems (e.g. machine break down) and outside of manufacturing systems (e.g. volatile market conditions).

In a first aspect, a method is provided for real time production scheduling. A current state of a manufacturing process in a manufacturing facility is identified. The state is input a neural network trained to generate a plurality of first scheduling policies given an input state of the production schedule. Using a Monte Carlo tree search, one or more second scheduling policies from the plurality of first scheduling policies are identified. An updated production schedule is generated using the one or more second scheduling policies.

In a second aspect, a method is provided for generating a production schedule. A plurality of simulations of production schedules are performed using simulation data from a manufacturing process simulator. Actions are sampled from the plurality of simulations using domain knowledge. A neural network is trained using reinforcement learning and Monte Carlo tree search, the training identifies polices for a current state of a production schedule that lead to a positive reward. A trained neural network is output for use in generating sub-optimal scheduling policies. Output scheduling polices from the neural network are optimized using the Monte Carlo tree search. Near-optimal scheduling polices are generated for a manufacturing process in a manufacturing facility from the optimized output scheduling policies.

In a third aspect, a device is provided for real time production scheduling. The system includes a production simulator, a deep reinforcement learning agent, and a Monte Carlo tree search agent. The production simulator is configured to generate simulation data of operation of a manufacturing process over time. The deep reinforcement learning agent is configured to input the simulation data and output one or more sub-optimal scheduling policies. The Monte Carlo tree search agent is configured to identify near optimal policies from the sub-optimal scheduling policies.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 depicts a system for real-time production scheduling according to an embodiment.

FIG. 2 depicts a workflow for real-time production scheduling according to an embodiment.

FIG. 3 depicts a neural network for real-time production scheduling according to an embodiment.

FIG. 4 depicts an example Monte Carlo tree search iteration.

FIG. 5 depicts a workflow for real-time production scheduling according to an embodiment.

FIG. 6 depicts a system for real-time production scheduling according to an embodiment.

### DETAILED DESCRIPTION

Embodiments provide real-time production scheduling by integrating DRL and MCTS algorithms. A manufacturing process simulator is used to train a DRL agent to identify the sub-optimal policies for a production schedule. A MCTS agent is implemented to speed up the search for near-optimal policies of higher quality from the sub-optimal policies.

Production scheduling is a complex task that performed efficiently may provide multiple rewards. The challenges of production scheduling may be exemplified by job shop scheduling where the solution is referred to as the job-shop problem. The job shop problem is an optimization problem in computer science and operations research in which jobs are assigned to resources at particular times. A simple version is as follows: a system is given N jobs J₁, J₂, . . . , J_{N} of varying processing times, that need to be scheduled on M machines with varying processing power, while trying to minimize the makespan. The makespan is the total length of the schedule (that is, when all the jobs have finished processing). Other variations such as flexible job shop scheduling may be related and include some of the same issues as the job shop problem.

Different algorithms and methods have been used to generate solutions to the job shop problem and other production scheduling problems. Current production scheduling algorithms may be classified into 3 categories: mathematical programming, heuristic algorithms, and machine learning algorithms. Each of the current algorithms include drawbacks that limit the ability of the algorithm to generate a production schedule efficiently or in real time.

For a mathematical programming algorithm, a production scheduling problem may be formulated as a mixed integer linear programming problem or mixed integer nonlinear programming problem. Exact solutions for the problem may be obtained from mathematical programming. However, mathematical programming is not an easily scalable method. Due to the size of the space and number of possibilities, the practical computation times for solving the program may be too long. Computing job shop schedules is an NP-hard problem. Alternative methods that take shortcuts or identify a solution that is close to optimal may be used.

Heuristic algorithms include algorithms such as first in first out (FIFO), shortest processing time first (SPT), and avoid most critical completion time (AMCC) among others. However, most of the heuristic algorithms formulate scheduling problems as sequential single-stage decision making which neglects the nature of multi-stage decision making of production scheduling. Heuristic algorithms shorten the computational time, but are inflexible and may be unable to identify optimal solutions for interconnected production schedules.

Machine Learning algorithm have been used as flexible solutions. Machine learning solutions have been developed that are based on the observation that no single dispatching rule in production scheduling exists that is consistently better than the rest in all the possible states (e.g. as used in a heuristic algorithm). Machine learning algorithms learn a policy that may automatically select the most appropriate dispatching rule at each moment via analyzing the previous performance of the system. Current machine learning algorithms are flexible but are still slow to react to changing conditions, e.g. machine breakdown and large deviations of utility prices. Once configured, current machine learning algorithms are set in stone and unable to handle real-time changes to a production schedule. This drawback limits the performance of state-of-the-art machine learning models, that are typically trained using stationary batches of data without accounting for situations in which the number of available machines may change (machine breakdown) and the information becomes incrementally available over time (e.g. utility price).

Real-time production scheduling is an enabling technology to Industry 4.0. In Industry 4.0, smart and flexible factories employ fully integrated and connected equipment and people to provide real-time process monitoring and optimization. Performance of smart factories is constantly predicted, improved and adapted on an ongoing basis. Therefore, a real-time production scheduling system plays a key role in management of interconnected components in this constantly volatile operating environment. Real-time scheduling has the potential to enable cost-effective, potentially high-throughput and high degree of mass customization.

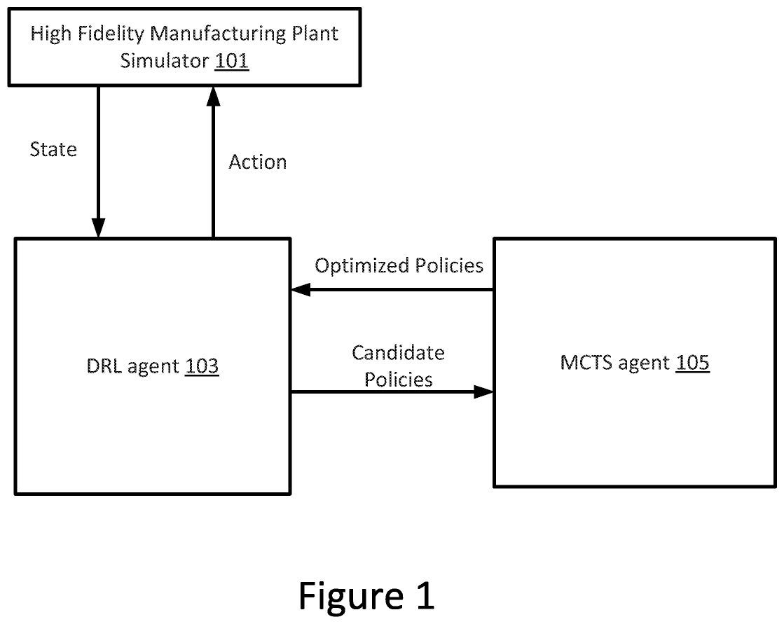

FIG. 1 depicts an example system workflow for providing real-time production scheduling avoiding one or more problems of previous machine learning approaches. As depicted in FIG. 1, embodiments include a manufacturing plant simulator 101, a DRL agent 103, and a MCTS agent 105.

The manufacturing plant simulator 101 provides imitation of the operation of a real-world manufacturing process over time. The simulator 101 is used to predict the future behaviors of manufacturing systems using particular scheduling policies, e.g. to estimate the expected accumulated reward from the current state to the final state. The policies are calculated from the DRL agent 103.

Starting from identified states and inputting a new scheduling signal, the simulator updates new states to the scheduler in real time. In order to bridge the gap between the simulator and actual manufacturing processes, random disturbances are introduced to relevant aspects of the environment, e. g. variable processing times, machine breakdown, and electricity prices. In alternative embodiments, the manufacturing plant is used instead of a simulator. By recording states and changes over time, many or most situations may be recorded.

Off-line training is performed to train a deep neural network offline using reinforcement learning (RL) and MCTS. RL provides the feedback signal for backpropagation algorithm to adjust the weights, and MCTS is used to speed up the offline training process. The trained deep neural network generates sub-optimal policies. However, when the sub-optimal policies are infeasible or include degraded performances for example, when machines fail or there are significant changes in state variables or environments, e.g. utility prices.

The state information is input into the DRL agent 103 from the simulator in real time. A neural network of the DRL agent 103 is trained by repeating episodes of start-to-finish simulation. In an embodiment, the DRL agent 103 uses a deep neural network (for example, connected with a long-short team memory LSTM network) to compress high-dimensional state variables from the simulator into low-dimensional features (e.g. latent space), capture the order dependence in scheduling problems, and map the generated state variables in the simulator into sub-optimal scheduling policies.

Online scheduling process uses MCTS algorithm to generate feasible polices or higher-quality optimized policies from the sub-optimal policies from deep neural networks. Online rollout is used to further optimize the policies.

The sub-optimal scheduling policies are fed into the MCTS agent 105. The MCTS agent 105 speeds up the search for near optimal polices in offline training phase. The MCTS agent 105 balances exploration and exploitation based on the available computation resources (for example, CPU time). In real-time scheduling, the MCTS agent 105 performs continuous rollout utilizing the continual acquisition of incrementally available information, e.g. machine breakdown, machine processing time etc. For example, the calculated policies from DRL agent may become infeasible because of machine breakdown or significant changes in environmental conditions, e.g. order priority. The rollout continues to search for a feasible/better scheduling policy and augment the schedule dynamically even after some tasks have already been dispatched. The continuous rollout provides that the schedule reacts to the dynamics of manufacturing systems in a timely manner, e.g. the schedule can be adjusted if, for example, a machine fails or conditions change (e.g. price of a commodity or power changes or CPU availability or delivery or environmental conditions).

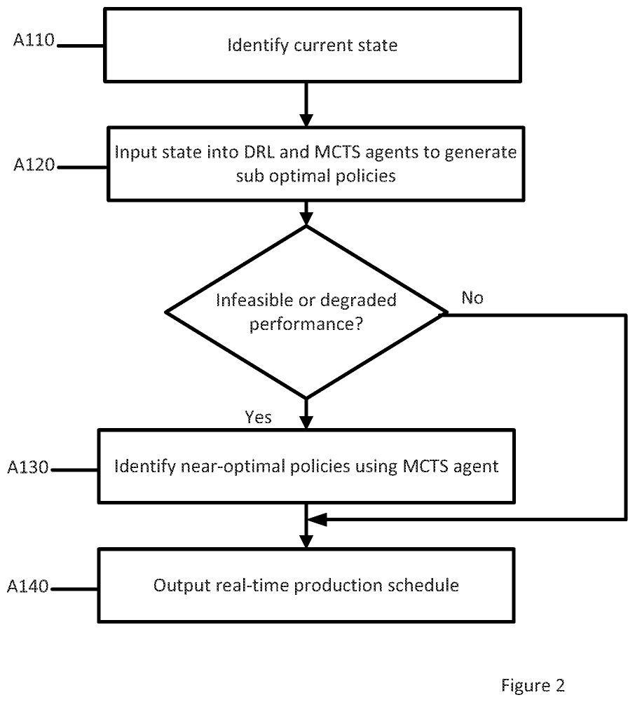

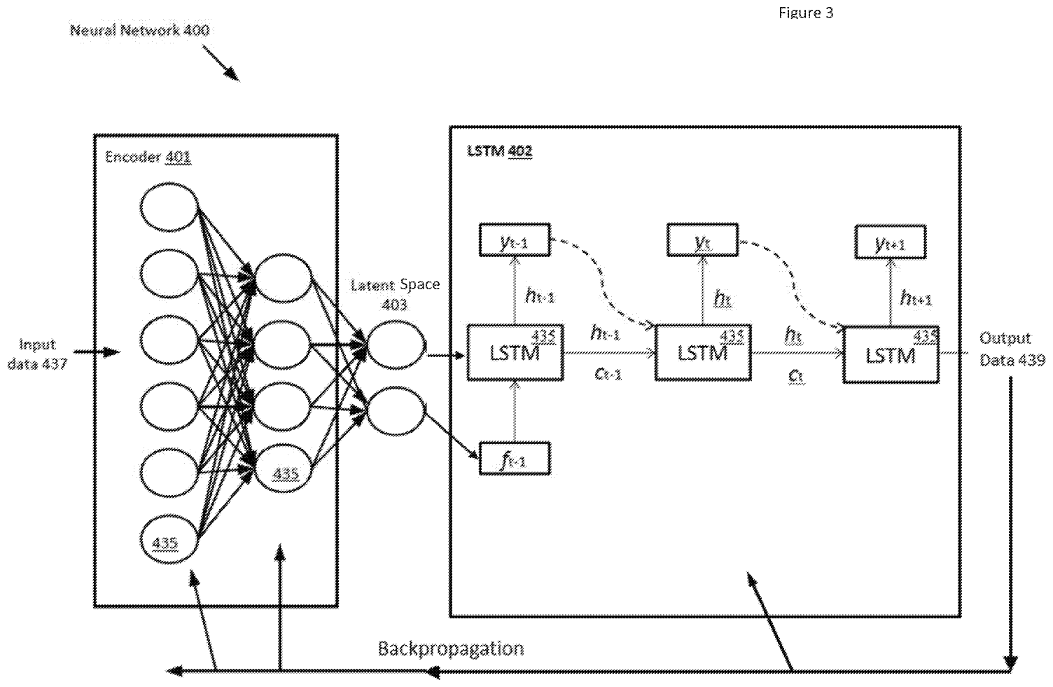

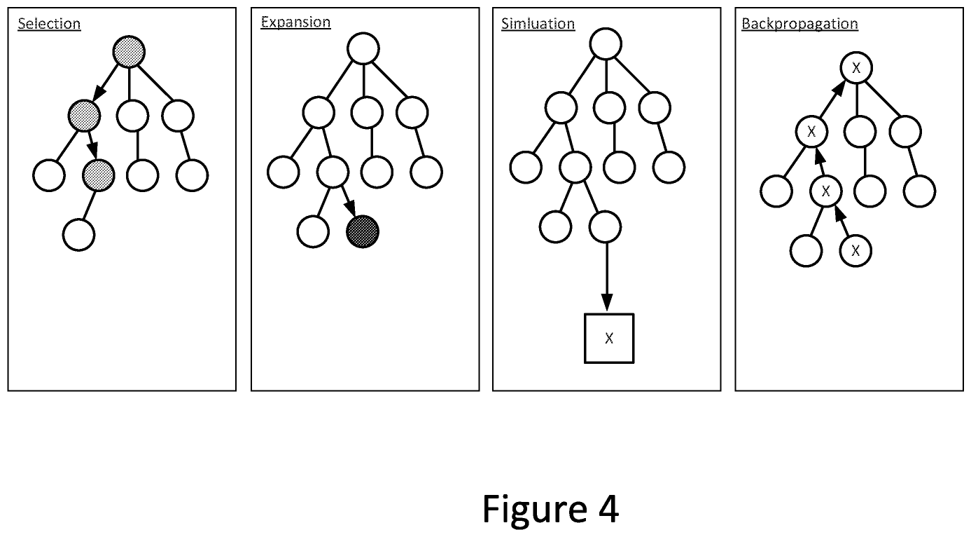

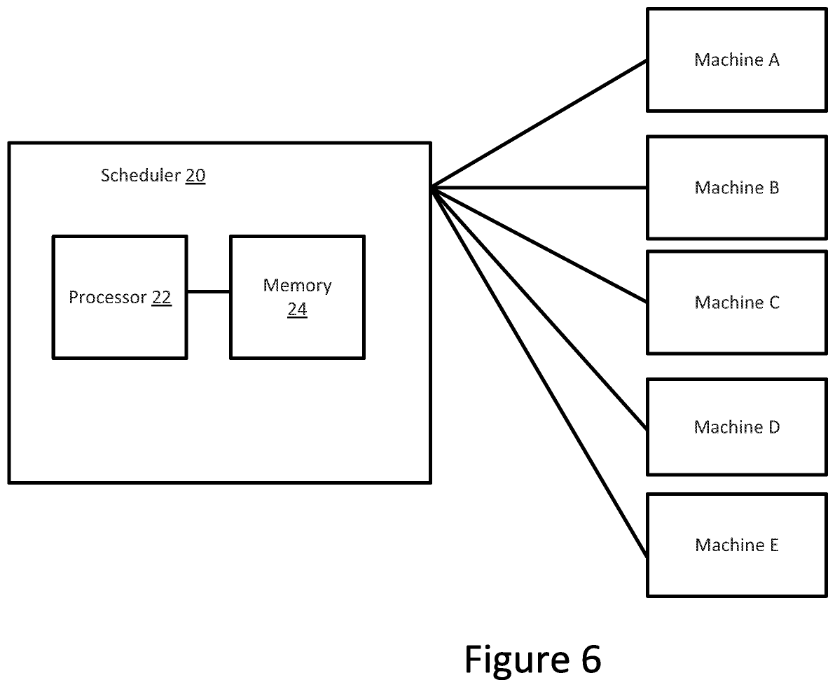

FIG. 2 depicts an example method of generating a production schedule using the system of FIG. 1. The acts are performed by the system of FIG. 1, FIG. 3, FIG. 4, FIG. 6 or other systems. Additional, different, or fewer acts may be provided. The acts are performed in the order shown (e.g., top to bottom) or other orders. The steps of workflow of FIG. 2 may be repeated. Certain acts or sub-acts may be performed prior to the method. For example, the DRL and/or MCTS agents may be pretrained or configured prior to generating a production schedule.

At act A110, a state of a production schedule is identified. The state of the production schedule may include information relating to factors for different machines (e.g. machine availability, product on machine, remaining execution time, machine input queue, machine output queue), different products, workers, environmental factors, cost parameters, supply, demand, transportation parameters, among other data that is related to the production schedule. The information may include a deterministic value or a probabilistic value for each of the factors. The state of the production schedule may be generated by the manufacturing simulator or may reflect actual real conditions for the manufacturing plant.

The state of production may be provided in real time. The state of production may be simulated or identified from a manufacturing plant. The simulator may be in communication with different agents or controllers that acquire and provide information relating the manufacturing process. The agents or controllers may be co-located with the simulator or may transmit information over a network. The simulator 101, DRL agent 103, and MCTS agent 105 may be located on site, located remotely, or, for example, located in a cloud computing environment. More than one simulator may be used to simulate the production environment. Each machine or component in a manufacturing environment may simulate its own environment and share information through a centralized simulator.

In an embodiment, future states may be predicted by integration of previous states in the simulator 101 and the actions generated from the DRL agent 103. For example, the simulator may predict multiple possible states for the future based on a current state and prior run simulations. The simulator may introduce random disturbances to relevant aspects of the environment, e. g. variable processing times, machine breakdown, and electricity prices when generating the future predicted states. Each of the future predicted states may be used below to identify futures steps and generate a production schedule. The production schedules for the possible future predicted states may be used if the disturbances come to pass. In an example, the simulator may provide a future state multiple steps in the future that includes a broken machine. If the broken machine functions properly the pathway is discarded. However, if the machine does break, the system may provide the production schedule generated by the fork. The number of the future predicted states being predicted may be limited by available computational resources, storage, or time for real-time scheduling tasks.

At act A120, the state is input into a neural network trained to generate a plurality of sub-optimal scheduling policies. In an embodiment, the neural network may be a deep reinforcement learning (DRL) network. The DRL is pre-trained (e.g. trained prior to act A110 or A120) to identify one or more sub-optimal policies. The term sub-optimal here refers to policies that may not be the ideal or optimal policy for proceeding with the production schedule. In an analogy for game theory, the sub-optimal policies may represent one or more possible moves that have been identified as “good” or likely to lead to a winning outcome. Because of the uncertainty in the system and the vast number of possibilities, the DRL may be unable to identify a single “optimal” policy. However, based on prior simulations (or records of actual production runs), the DRL is configured to identify the possible next steps for the current state that will lead to an efficient or beneficial outcome. In an example, based on prior simulations, the DRL may identify 2, 5, 10, 50, 100 or more possible “winning” steps or policies. The policies are input below into the MCTS to refine the determination and identify an “optimal” policy for the production schedule. Here an “optimal” policy denotes a policy, which is no worse than the policy from DRL agent.

In an embodiment, a neural network of the DRL agent 103 is trained offline using reinforcement learning (RL). For RL, the DRL agent 103 interacts with the simulator and, upon observing the consequences of its actions, learns to alter its own behavior in response to rewards received. The DRL agent 103 observes a state S(t) from the simulator at timestep t. The agent interacts with the simulator by taking an action A(t) in state S(t). When the agent takes an action, the simulator and the agent transition to a new state S(t+1) based on the current state and the chosen action. The best sequence of actions is determined by the rewards provided by the simulator. Every time the simulator transitions to a new state, the simulator may also provide a reward to the agent as feedback. The goal of the agent is to learn a policy (control strategy) that maximizes the expected return (cumulative, discounted reward).

The reward provided by the simulator 101 may be identified by the simulator 101 or may be determined by the MCTS agent 105. The reward may reflect a makespan or other quantifiable value that reflects the object or objects of the production schedule. The reward may be based on multiple different values and may be determined using an algorithm that weigh different values differently. For example, the reward may be calculated as a function of both a makespan and total cost (e.g. cost to run the machines).

Different neural networks may be used by the agent. As described above, one possibility is a deep reinforcement learning (DRL) network. The DRL network encodes high-dimensional state variables from the simulator 101 into low-dimensional features to identify the high reward steps.

FIG. 3 depicts an example neural network 400 that is used to generate the low-dimensional features 403 given a high-dimensional input state. The neural network 400 of FIG. 3 includes an encoder 401 and a long short term memory (LSTM) network 402. The neural network 400 is defined as a plurality of sequential feature units or layers 435. The machine network inputs state data 437, compresses the state data into a latent space 403 and maps the features from the latent space 403 using the LSTM 402. The encoder 401 is trained using classical unsupervised learning algorithm to train an autoencoder. The main idea is to generate the low-dimensional latent variable 403 by minimizing the difference between the output data 439 and the input data 437. The general flow of output feature values may be from one layer 435 to input to a next layer 435. The information from the next layer 435 is fed to a next layer 435, and so on until the final output. The layers may only feed forward or may be bi-directional, including some feedback to a previous layer 435. Skip connections may be provided where some information from a layer is feed to a layer beyond the next layer. The nodes of each layer 435 or unit may connect with all or only a sub-set of nodes of a previous and/or subsequent layer 435 or unit.

Various units or layers may be used, such as convolutional, pooling (e.g., max pooling), deconvolutional, fully connected, or other types of layers. Within a unit or layer 435, any number of nodes is provided. For example, 100 nodes are provided. Later or subsequent units may have more, fewer, or the same number of nodes. In general, for convolution, subsequent units have more abstraction. Each unit or layer 435 in the encoder 401 reduces the level of abstraction or compression. The encoder 401 encodes data to a lower dimensional space.

An LSTM network may be a recurrent neural network that has LSTM cell blocks in place of standard neural network layers. The LSTM network 402 may include a plurality of LSTM layers. In each cell of the LSTM network there may be four gates: input, modulation, forget and output gates. The gates determine whether or not to let new input in (input gate), delete the information because the information isn't important (forget gate) or to let the information impact the output at the current time step (output gate). The state of the cell is modified by the forget gate and adjusted by the modulation gate.

Each LSTM cell take an input that is concatenated to the previous output from the cell hₜ₋₁. The combined input is squashed via a tan h layer. The input is passed through an input gate. An input gate is a layer of sigmoid activated nodes whose output is multiplied by the squashed input. The input gate sigmoids may ignore any elements of the input vector that aren't required. A sigmoid function outputs values between 0 and 1. The weights connecting the input to these nodes may be trained to output values close to zero to “switch off” certain input values (or, conversely, outputs close to 1 to “pass through” other values). A state variable lagged one time step i.e. sₜ₋₁ is added to the input data to create an effective layer of recurrence. A recurrence loop is controlled by a forget gate—that functions similar to the input gate, but instead assists the network learn which state variables should be “remembered” or “forgotten.” Alternative structures may be used for LSTM cells or the LSTM network structure.

In an embodiment, a deep neural network is used, which includes one encoder network that includes one or more layers representing the encoding network of the net, and a second set of one or more layers that make up the LSTM network 402. The layers may be restricted Boltzmann machines or deep belief networks.

The neural network 400 may be a DenseNet. The DenseNet connects each layer to every other layer 435 in a feed-forward fashion. For each layer 435 in the DenseNet, the feature-maps of all preceding layers are used as inputs, and the output feature-map of that layer 435 is used as input into all subsequent layers. In the DenseNet, for each layer 435, the feature maps of all preceding layers are used as inputs, and its own feature maps are used as inputs into all subsequent layers. To reduce the size of the network, the DenseNet may include transition layers. The layers include convolution followed by average pooling. The transition layers reduce height and width dimensions but leave the feature dimension the same. The neural network 400 may further be configured as a U-net. The U-Net is an auto-encoder in which the outputs from the encoder-half of the network are concatenated with the mirrored counterparts in the LSTM-half of the network.

Other network arrangements may be used, such as a support vector machine. Deep architectures include convolutional neural network (CNN) or deep belief nets (DBN), but other deep networks may be used. CNN learns feed-forward mapping functions while DBN learns a generative model of data. In addition, CNN uses shared weights for all local regions while DBN is a fully connected network (e.g., including different weights for different areas of the states). The training of CNN is entirely discriminative through back-propagation. DBN, on the other hand, employs the layer-wise unsupervised training (e.g., pre-training) followed by the discriminative refinement with back-propagation if necessary. In an embodiment, the arrangement of the machine learnt network is a fully convolutional network (FCN). Alternative network arrangements may be used, for example, a 3D Very Deep Convolutional Networks (3D-VGGNet). VGGNet stacks many layer blocks containing narrow convolutional layers followed by max pooling layers. A 3D Deep Residual Networks (3D-ResNet) architecture may be used. A Resnet uses residual blocks and skip connections to learn residual mapping.

In an embodiment, there are a number of neural networks trained in parallel and the best one may be selected for training data generation every checkpoint after evaluation against a best current neural network.

After being generated, a check is performed to determine if the sub optimal policies are infeasible or if the performance of the manufacturing plant has been degraded. For example, in the event of a machine failure or degradation, a new policy will need to be identified as the old policy may be infeasible or not optimal. If, conditions do not change, the suboptimal policy generated by the DRL may be used to generate the production schedule.

At act A130, the sub-optimal scheduling policies are input into a MCTS agent 105 trained to identify one or more near optimal scheduling policies from the plurality of sub-optimal scheduling policies. The sub-optimal scheduling polices may represent features output by the DRL that suggest the next step that will lead to a winning solution. The features include a low dimensionality than the input state data. The low dimensionality limits the size of the search. However, because the space is large and there are a large number of possibilities, the DRL may be unable to identify an optimal policy. The MCTS agent 105 assists the DRL in identifying and selecting the next step in the production schedule.

FIG. 4 depicts the workflow for a MCTS. The MCTS includes iteratively building a search tree until a predefined computational budget, for example, a time, memory or iteration constraint is reached, at which point the search is halted and the best performing root action is returned. Each node in the search tree represents a state and directed links to child nodes represent actions leading to subsequent states. The MCTS includes at least four steps that are applied at each search iteration. The steps of selection, expansion, simulation, and backpropagation are depicted in FIG. 4. For an initial selection, the MCTS uses the sub-optimal policies provided by the DRL agent 103.

For the selection step, starting at a current state, e.g. a root node, a child selection policy is recursively applied to descend through the tree. A node is expandable if it represents a nonterminal state and has unvisited (e.g. unexpanded) children. In an embodiment, the MCTS uses upper confidence bounds (UCT) for the selection step. For the MCTS to explore the policy space under a bounded regret, an upper confidence bound term may be added to the utility when deciding an action. Each node in the tree maintains an average of the rewards received for each action and the number of times each action has been used. The agent first uses each of the actions once and then decides what action to use based on the size of the one-sided confidence interval on the reward computed based on a Chernoff-Hoeffding bound equation. A constant C is used to control the exploration-exploitation tradeoff. The constant may be tuned for a specific industrial task or production environment. The balance between exploration and exploitation may be adjusted by modifying C. Higher values of C gives preference to actions that have been explored less, at the expense of taking actions with the highest average reward.

In another embodiment, Rapid Action Value Estimation (RAVE) may be applied. RAVE provides that the agent learns about multiple actions from a single simulation, based on an intuition that in many domains, an action that is good when taken later in the sequence is likely to be good right now as well. RAVE maintains additional statistics about the quality of actions regardless of where the actions have been used in the schedule.

For the expansion step, one or more child nodes are added to expand the tree, according to the available actions. The available actions may be defined by the manufacturing plant simulator 101. The actions may be limited to all possible actions for each machine in the plant simulator 101. The actions may be limited to probable (or likely or promising) actions as defined by prior run simulations.

For the simulation step, a simulation is run from the new node(s) according to a default policy to produce an outcome. The outcome may be evaluated, for example, a makespan or time to run. Other evaluation methods such as efficiency or cost may be used to evaluate the production. As an alternative to a policy defined by the DRL, the simulation step may use a different policy that creates a leaf node from the nodes already contained within the search tree. For the backpropagation step, the simulation outcome is back-propagated through the selected nodes to update statistics for the nodes.

The MCTS agent uses multiple iterations to estimate the value of each state in a search tree. Each node of the tree represents a state. Moving from one node to another simulates an action or actions performed by a manufacturing system (machine). At the end of the simulation the production schedule may be identified by tracing the path along the selected nodes of the tree. For the MCTS algorithm, as more simulations are executed, the search tree grows larger and the relevant values become more accurate. A policy used to select actions during search is also improved over time, by selecting children with higher values. The policy converges to a near-optimal policy and the evaluations converge to a stable value function.

In an embodiment, a depth of the search may be reduced by position evaluation: truncating the search tree at state (s) and replacing the subtree below (s) by an approximate value function v(s)≈v*(s) that predicts the outcome from state (s). The breadth of the search may also be reduced to y sampling actions from a policy p(a|s) that is a probability distribution over possible moves (a) in position (s). For example, Monte Carlo rollouts search to maximum depth without branching at all, by sampling long sequences of actions for both players from a policy (p). Averaging over such rollouts may provide an effective position evaluation.

Domain-specific knowledge may be employed when building the tree to help the exploitation of some variants. One such method assigns nonzero priors to the number of positive outcomes and played simulations when creating each child node, leading to artificially raised or lowered average positive rates that cause the node to be chosen more or less frequently, respectively, in the selection step. Values may be assigned and stored in the tree prior to performing act A130.

The output of the MCTS is one or more near optimal scheduling policies. The near optimal scheduling policy may be a policy that has the highest score in the MCTS that leads to a positive outcome. The near optimal scheduling policy may be a policy that has the highest probability of the leading to the optimal outcome. For different production tasks, the reward function may be defined to drive the MCTS to select a policy that makes the most sense for the production task at hand. For one task, time may be the most important factor, while for another, cost may be the most important. A rewards algorithm for the MCTS may be adjusted depending on the task.

At act A140, a production schedule is generated using the one or more near optimal scheduling policies. The production schedule may include one or more steps or actions to perform as defined by the one or more optimal policies. The process of A110-A140 may be continuously run during a production run. In a scenario where there is a change to the underlying manufacturing parameters (e.g. a cost or machine change), the production schedule may be adapted. The change in state may be input into the DRL directly or using the manufacturing plant simulator 101. The DRL agent 103 and MCTS agent 105 may use the updated search and parameters to generate a new near optimal production schedule given the new state and manufacturing parameters. In an embodiment, the MCTS performs continuous rollout. The production schedule may be updated if the MCTS identifies a more promising action.

The DRL agent 103 and MCTS agent 105 may be trained and configured prior to the acts of FIG. 2. The DRL agent 103 is configured using data from the simulator 101 and the predefined reward function to identify the sub-optimal policies. The MCTS algorithm may be used for both training the DRL agent 103 to speed up training process and also for determining optimal polices of higher quality during application. In an embodiment, hundreds, thousands, or more simulations may be run to train the DRL agent 103 to identify the sub-optimal policies.

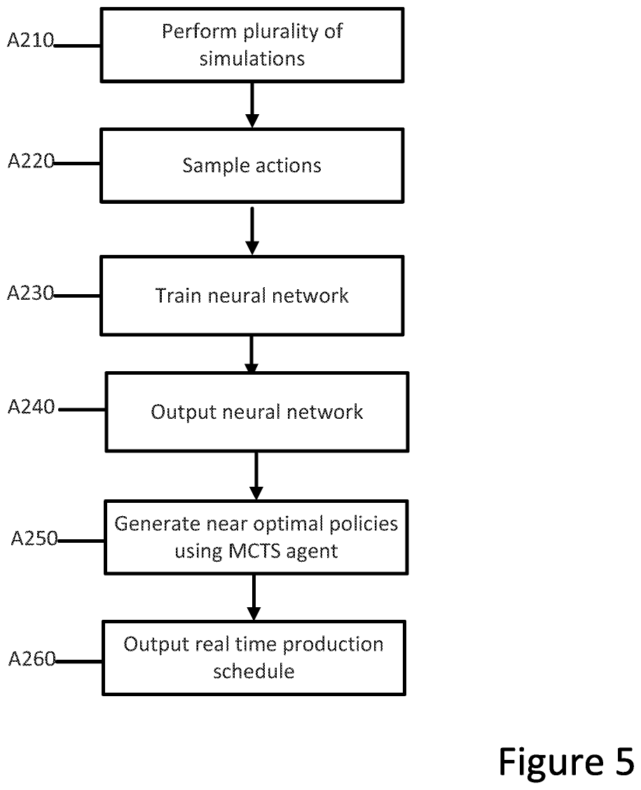

FIG. 5 depicts an example method for generating a machine learnt agent configured for efficient real time production scheduling. The acts are performed by the system of FIG. 1, FIG. 3, FIG. 4, FIG. 6 or other systems. Additional, different, or fewer acts may be provided. The acts are performed in the order shown (e.g., top to bottom) or other orders. The steps of workflow of FIG. 5 may be repeated.

At A210, the DRL agent 103 (agent) runs a plurality of simulations using data from the simulator 101 and identifies a reward using a predefined reward function. A high fidelity manufacturing plant simulator 101 (simulator 101) is configured to generate new states given an action from the agent. The simulator 101 and the agent are configured to run simulations from a state to an end of a production schedule. The rewards for each state and complete simulation may be calculated using a known reward function.

Reinforcement learning (RL) provides learning through interaction. The agent interacts with the simulator 101 and, upon observing the consequences of selected actions, the agent learns to alter its own behavior in response to rewards received. The agent including the neural network 400, receives a state s(t) from the simulator 101 at timestep t. The agent interacts with the simulator 101 by providing an action at state s(t). When the agent provides the action, the simulator 101 transitions to a new state s(t+1) based on the current state and the chosen action. The new state s(t+1) is returned to the agent to await a further action. The state is a sufficient statistic of the simulation and includes information for the agent to suggest an optimal action at that time. The optimal action may not end up leading to the optimal reward due to the complexity of the production system and uncertainties that may alter the environment. For example, a failure of a machine may alter the predictions. Further, the large number of possibilities may only allow the agent to make a best prediction of an optimal action rather than providing an absolution prediction.

The estimated optimal sequence of actions is calculated as a function of rewards provided by the simulator 101 (the rewards is calculated and provided to the simulator 101 or agent). Every time the simulator 101 transitions to a new state, a reward r(t+1) may be provided to the agent as feedback. The goal of the agent is to learn a policy that maximizes the expected return (cumulative, discounted reward). Given a state, a policy returns an action to perform; an optimal policy is any policy that maximizes the expected return for the production schedule.

The agent is used to understand the state of the production and use the understanding to intelligently guide the search of the MCTS. The deep learning agent is trained to identify the current state and the possible legal actions. From this information, the deep learning agent identifies which action should be taken and whether or not there will be a positive reward. A positive reward may be defined as completing the schedule under a certain budget (e.g. time, computation, energy, etc.).

The DRL agent calculates sub-optimal policies, which are fed into MCTS agent. The MCTS searches a tree of possible actions and future actions. When the algorithm starts, the tree is formed by a root node that holds the current state of a production schedule. During a selection step, the tree is navigated from the root until a maximum depth or the end of the production schedule has been reached. In every one of these action decisions, the MCTS balances between exploitation and exploration. The MCTS chooses between taking an action that leads to states with the best outcome found so far, and performing an action that leads to less explored future states, respectively

If, during the tree selection phase, a selected action leads to an unvisited state, a new node is added as a child of the current one (expansion phase) and a simulation step starts. The MCTS executes a Monte Carlo simulation (or roll-out; default policy) from the expanded node. The roll-out is performed by choosing random (either uniformly random, or biased) actions until the production schedule ends or a pre-defined depth is reached, where the state of the production schedule is evaluated. After the rollout, the number of visits N(s) and value of the state Q (s, a) are updated for each node visited, using the reward obtained in the evaluation of the state. The steps are executed in a loop until one or more termination criteria are met (such as number of iterations or an amount of time).

At A220, the agent samples actions from the simulation data. The agent may identify actions at random. Alternatively, the agent may select actions at regular intervals, for example, every 10^{th} action. The agent may sample actions using domain knowledge, e.g. using known heuristic scheduling algorithms to sample promising actions. The sampled actions may be used as training data for the neural network.

At A230, a neural network is trained using reinforcement learning and MCTS algorithms, the training identifies polices for a current state of a production schedule that lead to a positive reward. The neural network is trained using the sampled action of A220. For each action, the agent identifies both the results of the MCTS evaluations of the positions how “good” the various actions in the positions were based on the lookahead at the MCTS and the eventual outcome. The agent is able to record the information as the simulations are run to the end of the production schedule giving the agent both the results at the position and the overall result.

The neural network 400 is trained using the recorded results to identify sub-optimal policies for a current state of a production schedule. The neural network 400 is trained to identify polices that reflect the rewards. The neural network 400 is also trained so that neural network 400 is more likely to suggest policies similar to those that led to positive outcomes and less likely to suggest policies that are similar to those that led to negative outcomes during the simulations. The neural network 400 may be trained using reinforcement learning. For reinforcement learning, a feedback mechanism is used to improve the performance of the network. The agent collects reward in the MCTS at different states, the neural network will map these states to their corresponding values based on the reward collected. By comparing the values, the neural network can decide which states are more favorable and generate policy that leads to high-value states. To train the network, the encoded input states are fed forward to generate the outputs which will in turn be compared to the target values given by the MCTS. The errors between the generated outputs and the target values are then propagated back to update the weights of the neural networks.

In an embodiment, the network takes the state and processes it with convolutional and fully connected layers, with ReLU (Rectified Linear Unit) nonlinearities in between each layer. At the final layer, the network outputs a discrete action, that corresponds to one of the possible actions for the production schedule. Given the current state and chosen action, the simulator 101 returns a new state. The DRL agent 103 the new state to calculate the initial policies, which are fed into the MCTS agent. MCTS continuously rolls out based on the new state to shape a more accurate value of the reward .

In an embodiment, the neural network 400 is an encoder of an autoencoder connected to a LSTM network. The encoder is configured to learn a low-dimensional representation 403 of a high-dimensional data set 437. Rather than pre-programming the features and trying to relate the features to attributes, the deep architecture of the neural network 400 is defined to learn the features at different levels of abstraction based on an input state data. The features are learned to reconstruct lower level features (e.g., features at a more abstract or compressed level). For example, features for reconstructing a state are learned. For a next unit, features for reconstructing the features of the previous unit are learned, providing more abstraction. Each node of the unit represents a feature. Different units are provided for learning different features. Learned features are fed into the LSTM network, which maps the learned features into sub-optimal policies.

At A240, the system outputs a trained network. The neural network 400 includes: 1) an encoder network that is trained to compress/encode high-dimensional state variables from the simulator 101 into low-dimensional features 403; 2) The LSTM network generates policies from the low-dimensional features 403. The network maps the generated policies from the encoder network 401 into sub-optimal scheduling policies.

At A250, the network is further enhanced with MCTS. The trained network may be configured to identify solutions under optimal conditions. The calculated policies from the DRL agent may become infeasible or inefficient because of major changes in the state variables or the environment conditions, e.g. machine breakdown and varying utility costs. To optimize the scheduling policies given the change, a MCTS agent is used to generating the near optimal scheduling policies. A MCTS uses a tree search algorithm based on statistical sampling. In combination an upper confidence bound, the MCTS agent is configured to balance between exploration and exploitation of the tree based on specific domains and problems. The MCTS provides an online search mechanism to identify which of the sub optimal scheduling policies should be implemented. When the algorithm starts, the tree is formed only by the root node that represents the current state of the production process given by the DRL agent 103. During the selection step, the tree is navigated from the root until a maximum depth or the end of the production process has been reached. In every one of the action decisions, MCTS balances between exploitation and exploration. The MCTS chooses between taking an action that leads to states with the best outcome found so far, and performing a move to go to less explored states, respectively.

At act A260, the MCTS agent outputs near-optimal scheduling policies. The output of the MCTS agent is one or more near-optimal scheduling policies for a manufacturing process in the manufacturing facility. The near-optimal scheduling policies may be determined in real time during operation of the manufacturing facility. The near-optimal scheduling policies provide instructions to one or more machines or modules in the manufacturing facility, for example, directing the output of one machine to another machine or changing the workflow of the manufacturing process.

In an embodiment, multiple networks may be trained. After a number of iterations (e.g. 100, 1000, 10,000 or more), a primary neural network 400 is evaluated against a previous best version. The version that performs best is used to generate actions for the simulations that generate the simulated responses for training the network.

FIG. 6 depicts one embodiment of a system for a production scheduler. FIG. 6 includes a scheduler 20 and a plurality of Machines A-E. Each machine A-E may be set up to perform a different task using different resources. For example, machine A may perform Task 01 using material from Machine B and Machine C. Machine B may perform Task 02 using raw materials from machine A. Machine C may perform Task 03 that uses materials from machine B and Machine D and so on. The machines may be dependent on one another. Other machines, tasks, workers, material, etc. may not be shown. A goal of the scheduler 20 is to quickly and efficiently generate an efficient schedule for operation of the machines A-E in order to generate, for example, a final product. The scheduler 20 uses a combination of DRL and MCTS algorithms to efficiently provide a real times schedule for the machines A-E.

The scheduler 20 includes a processor 22, a memory 24, and optionally a display and input interface. The scheduler may communicate with the machines (e.g. production plant or facility) over a network. The scheduler may operate autonomously and may provide real time instructions to the facility based on changing condition (machine failure, resource costs, delivery, worker changes, etc.).

The memory 24 may be a graphics processing memory, a video random access memory, a random-access memory, system memory, cache memory, hard drive, optical media, magnetic media, flash drive, buffer, database, combinations thereof, or other now known or later developed memory device for storing data. The memory 24 is part of a computer associated with the processor 22, part of a database, part of another system, or a standalone device. The memory 24 may store configuration data for a DRL agent 103, a manufacturing simulator 101, and a MCTS agent 105. The memory 24 may store an instruction set or computer code configured to implement the DRL agent 103, the manufacturing simulator 101, and the MCTS agent 105.

The memory 24 or other memory is alternatively or additionally a non-transitory computer readable storage medium storing data representing instructions executable by the programmed processor 22 or optimizing one or more values of parameters in the system. The instructions for implementing the processes, methods and/or techniques discussed herein are provided on non-transitory computer-readable storage media or memories, such as a cache, buffer, RAM, removable media, hard drive, or other computer readable storage media. Non-transitory computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code, and the like, operating alone, or in combination. Likewise, processing strategies may include multiprocessing, multitasking, parallel processing, and the like.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The processor 22 may be configured to provide high-quality imitation of the operation of a real-world manufacturing process over time. Starting from identified states and inputting a new scheduling signal, the processor 22 updates new states to the scheduler in real time. In order to bridge the gap between the processor 22 and an actual manufacturing processes, random disturbances are introduced to relevant aspects of the environment, e. g. variable processing times, machine breakdown, and utility prices.

The state information may be used in real time. A neural network 400 stored in memory 24 is trained by repeating episodes of start-to-finish simulation. In an embodiment, the processor 22 uses a deep neural network 400 (for example, an encoder connected with a LSTM network) to compress/encode high-dimensional state variables from the simulator 101 into low-dimensional features 403. The processor 22 uses the low-dimensional features 403 to identify sub-optimal scheduling policies.

The sub-optimal scheduling policies are used by the processor 22. The processor 22 speeds up the search for the optimal polices. The processor 22 is configured to return an initial schedule based on static state information. The processor 22 balances exploration and exploitation based on the available computation resources (for example, CPU time). The processor 22 performs continuous rollout. The rollout continues to search for a feasible/better scheduling policy and augment the schedule dynamically even after some tasks have already been dispatched. The processor 22 and the balancing of exploration and exploitation provide that a schedule may be computed in a limited time frame. The continuous rollout provides that the schedule reacts to the dynamics of manufacturing systems in a timely manner, e.g. the schedule can be adjusted if, for example, a machine fails, or conditions change (e.g. price of a commodity or power changes or CPU availability or delivery or environmental conditions).

The processor 22 is a general processor, central processing unit, control processor, graphics processor, digital signal processor, three-dimensional rendering processor, image processor, application specific integrated circuit, field programmable gate array, digital circuit, analog circuit, combinations thereof, or other now known or later developed device for generating a flow control plan. The processor 22 is a single device or multiple devices operating in serial, parallel, or separately. The processor 22 may be a microprocessor located in a machine or at a centralized location. The processor 22 is configured by instructions, design, hardware, and/or software to perform the acts discussed herein.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A method for real time production scheduling, the method comprising:
identifying a current state of a manufacturing process in a manufacturing facility;
inputting the state into a neural network trained to generate a plurality of first scheduling policies given an input state of the production schedule;
identifying, using a Monte Carlo tree search, one or more second scheduling policies from the plurality of first scheduling policies; and
generating an updated production schedule using the one or more second scheduling policies.

2. The method of claim 1, wherein the neural network is a deep neural network that is trained by integration of reinforcement learning and the Monte Carlo tree search.

3. The method of claim 2, wherein the deep neural network comprises an auto-encoder network trained to generate a feature map comprising a compact representation of input state data, and a LSTM network trained to map the learned features into sub-optimal polices.

4. The method of claim 3, wherein the deep neural network is trained using simulation data generated using a manufacturing process simulator.

5. The method of claim 4, wherein the deep neural network is trained to identify rewarding actions from samples of the simulation data.

6. The method of claim 1, further comprising:
generating the state of the production schedule using a manufacturing process simulator.

7. The method of claim 6, wherein the state is generated using data relating to machine availability, product on machine, remaining execution time, machine input queue, and machine output queue.

8. The method of claim 1, wherein a depth of the Monte Carlo tree search is reduced by position evaluation.

9. The method of claim 1, wherein a depth of the Monte Carlo tree search is truncated by a time constraint.

10. The method of claim 1, wherein a depth of the Monte Carlo tree search is truncated by a computational constraint.

11. A method for generating a production schedule, the method comprising:
performing a plurality of simulations of production schedules using simulation data from a manufacturing process simulator;
sampling actions from the plurality of simulations using domain knowledge;
training a neural network using reinforcement learning and Monte Carlo tree search, the training identifies polices for a current state of a production schedule that lead to a positive reward;
outputting a trained neural network for use in generating sub-optimal scheduling policies;
optimizing output scheduling polices from the trained neural network using the Monte Carlo tree search; and
generating near-optimal scheduling polices for a manufacturing process in a manufacturing facility from the optimized output scheduling policies.

12. The method of claim 11, wherein training the neural network comprises:
calculating a positional reward value and an outcome reward value for an action using a reward function.

13. The method of claim 11, wherein for optimizing, the Monte Carlo tree search is truncated by a time constraint.

14. The method of claim 11, wherein for optimizing, the Monte Carlo tree search is truncated by a computational constraint.

15. The method of claim 11, wherein optimizing is performed in real time as the manufacturing process progresses.

16. The method of claim 11, wherein the neural network comprises an encoder and a LSTM network.

17. A system for real time production scheduling, the system comprising:
a production simulator configured to generate simulation data of operation of a manufacturing process over time;
a deep reinforcement learning agent configured to input the simulation data and output one or more sub-optimal scheduling policies; and
a Monte Carlo tree search agent configured to identify near optimal policies from the sub-optimal scheduling policies.

18. The system of claim 17, wherein the production simulator is configured to insert random disturbances into the simulation data.

19. The system of claim 17, wherein the deep reinforcement learning agent comprises an encoder network trained to compress high-dimensional state variables from the simulation data into low-dimensional features, and a LSTM network trained to map the learned features into sub-optimal polices.

20. The system of claim 17, wherein the Monte Carlo tree search agent performs continuous rollout during implementation of a production schedule.
